(19) United States
(12) Patent Application Publication
(10) Pub. No.: US 2020/0364787 A1
(43) Pub. Date: Nov. 19, 2020

(54) Fixed Income Optimizer

(71) Applicant: JPMorgan Chase Bank, N.A., New York, NY (US)

(72) Inventors: Eric Isenberg, Hoboken, NJ (US); Naveen Kumar, London (GB); Hang Su, New York, NY (US); David Molay, New York, NY (US); David D. Lin, Tuxedo Park, NY (US); Kent Jiatian Zheng, London (GB); Jie Song, Berkeley Heights, NJ (US); Qiwei Huang, Monroe, NJ (US); Phillip Lin, Sunnyside, NY (US)

(21) Appl. No.: 16/410,567

(22) Filed: May 13, 2019

(51) Int. Cl. G06Q 40/04; G06N 5/02

(52) U.S. Cl. CPC G06Q 40/04; G06N 5/02

(57) ABSTRACT

Systems and methods for managing fixed income assets are provided. Exemplary systems and methods may utilize an optimization client configured to accept selection of one or more constraints associated with fixed income assets, a knowledge engine configured to retrieve data related to available fixed income assets from a fixed income index feed, and an optimization engine configured to generate an optimized fixed income trade list.

### TECHNICAL FIELD

The present disclosure generally relates to systems and methods for optimizing and managing fixed income assets.

### BACKGROUND

In the field of investment management, fixed income assets, e.g. bonds, treasury bills, Guaranteed Investment Certificates (GIC), etc., are often used to provide an investor a reliable return in the form of fixed periodic payments. In some cases, investors look to passive fixed income funds, mandates, and exchange traded funds (ETFs) to establish a fixed income investment position. For the organizations or financial institutions tasked with managing fixed income funds, mandates, and ETFs, it is often a difficult and resource intensive process. For instance, compared to major equity indexes (e.g. NASDAQ Composite, Dow Jones Industrial Average, and S&P 500), the fixed income index requires tracking an index that consists of tens of thousands of illiquid fixed income assets or products. Furthermore, bonds traded on the fixed income index often have a large minimum trade size and lot size, adding to the complexity.

The creation process surrounding fixed income ETFs adds further complexity. For most fixed income ETFs, portfolio managers (PMs) receive inflows to the fund primarily through authorized participants (APs). The authorized participants are market makers for the ETF in the secondary market who have the opportunity to come in to do a creation when they do not have enough shares of the ETF to deliver to meet demand in the market. A creation involves the issuer's PMs creating new shares of the ETF and delivering them to the APs. The APs deliver bonds, or cash to the issuer's portfolio managers in exchange for new shares of the ETF. In their role as market makers, APs seek to minimize their cost on the creation to the greatest extent possible by delivering out securities that they least want, or that they can source the most cheaply.

The unique aspect of fixed income ETFs is that the creation event is a negotiation. The APs want to deliver bonds that they either have in inventory or can source cheaply. The PMs are incentivized to accommodate the AP because doing so allows APs to keep the bid/ask spread low on the ETF in the secondary market. However, PMs have a fiduciary responsibility to only take inflows that allow the fund to best meet their investment objectives. The burden of proof that the securities received on the inflow meet the investment objectives in the fund falls on the issuer. Additionally, the APs consider the time taken to complete a negotiation with the PMs when determining the bid/ask spread. Less time is strongly preferred.

APs often come to the PMs with a large list of securities that they are willing to deliver, often with a maximum size of each bond that the AP is capable of delivering. PMs can then choose which bonds, if any, to select from the AP, and at what size notional amounts they will choose. Regulations ensure that the PMs cannot accept delivery of a bond in a size that is less than the minimum denomination on the bond, or in an amount that is not rounded to the minimum increment on the bond. The minimum denomination and minimum increment differ for each bond. Additionally, it would be inappropriate for the PMs to request delivery of an amount that would leave the AP holding a remaining position in a bond that is smaller than the minimum denomination, or even a position that is smaller than typical trade sizes on the bond. This would be considered an ‘odd lot’ and would be difficult for the AP to sell. This process is burdensome and inefficient and results in a sub-optimal exchange of fixed income assets.

It is therefore appreciated that a need exists for systems and methods for optimizing management of fixed income assets.

### SUMMARY

In an exemplary embodiment, system for managing fixed income assets is provided. The system comprises: an optimization client configured to accept selection of at least one constraint associated with fixed income assets; a knowledge engine configured to retrieve data related to available fixed income assets, wherein the retrieved data comprises at least index data from a fixed income index feed; and, an optimization engine configured to: generate an optimization problem based on the at least one constraint and the data retrieved by the knowledge engine; solve the optimization problem; and, generate an optimized fixed income trade list based on the optimization problem.

In another exemplary embodiment, a method for managing fixed income assets is provided. The method comprising: receiving at least one constraint associated with fixed income assets; receiving data from a knowledge engine, wherein the data received comprises at least index data from a fixed income index feed; generating an optimization problem based on the at least one constraint and the data received by the knowledge engine; solving the optimization problem; and, generating an optimized fixed income trade list based on the solved optimization problem.

In yet another exemplary embodiment, a system for managing fixed income assets is provided. The system comprising: an optimization client configured to: select at least one constraint associated with fixed income assets; transmit the selected at least one constraint to an optimization engine; receive an optimized fixed income trade list from the optimization engine; and, execute at least one trade associated with the optimized fixed income trade list.

These and other objects, features and advantages of the present disclosure will become apparent from the following detailed description of illustrative embodiments thereof, which is to be read in connection with the accompanying drawings.

### BRIEF DESCRIPTION OF THE DRAWINGS

These and other features of the present disclosure will become better understood with regard to the following description and accompanying drawings in which:

FIG. 1 shows an exemplary fixed income optimization system.

FIG. 2 shows an exemplary method of executing a fixed income asset trade according to exemplary embodiments of the present disclosure;

FIG. 3 shows a screenshot of an exemplary user interface for an exemplary fixed income optimization system;

FIG. 4 shows another screenshot of an exemplary user interface for an exemplary fixed income optimization system;

FIG. 5 shows yet another screenshot of an exemplary user interface for an exemplary fixed income optimization system.

### DETAILED DESCRIPTION

Aspects and implementations of the present disclosure will be understood more fully from the detailed description given below and from the accompanying drawings of the various aspects and implementations of the disclosure. This should not be taken to limit the disclosure to the specific aspects or implementations, but explanation and understanding only.

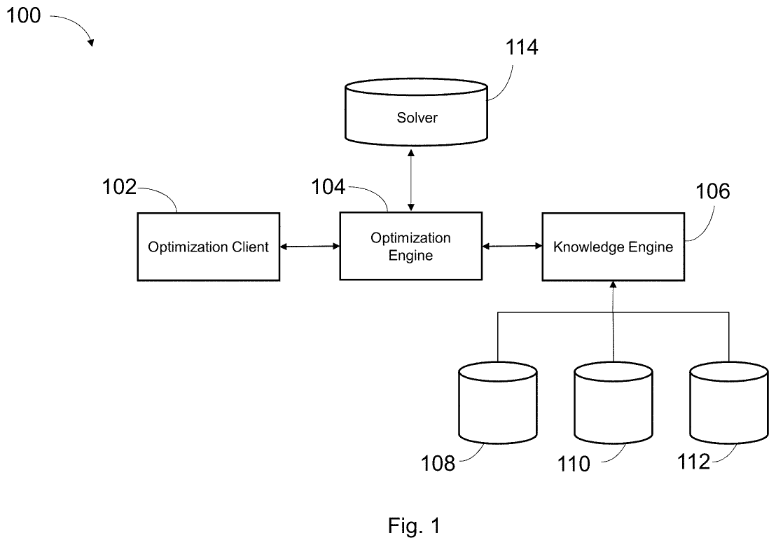

FIG. 1 shows an exemplary Fixed Income Optimization system 100. The system 100 comprises at least an Optimization Client 102, Knowledge Engine 106, Optimization Engine 104, and Solver 114. The system 100 may be used by one or more users to generate an optimized trade list for fixed income assets associated with the fixed income index. A user, e.g. portfolio manager (not shown), may set parameters for a desired fixed income asset trade at the Optimization Client 102. Optimization Client 102 may comprise a user interface configured to be displayed on an electronic display, such as those associated with a desktop or laptop computer, smartphone, or the like. A user's identity may be authenticated or verified by the Optimization Client 102, for example, through use of a username and password. In some embodiments, Optimization Client 102 is accessible via a website, electronic portal, or the like.

At Optimization Client 102, a user may set or select one or more constraints associated with selection of one or more fixed income assets. The constraints further specify what type of fixed income asset is desired. In some embodiments, constraints may be applied to a single fixed income asset or may be applied as an average of a plurality of fixed income assets, such as an ETF. Constraints may be categorized as analytic constraints, characteristic constraints, or transaction specific constraints. Analytic constraints may comprise, for example, Key Rate Durations (KRDs), Option Adjusted Duration (OAD), Option Adjusted Spread (OAS), Region/Country Weight, Convexity, Effective Duration, Yield, Spread Duration, etc. Characteristic constraints may comprise, for example, Sector, Ratings, Bond Type, Seniority, Currency, Country of Risk, Asset Class, Age, Liquidity, Issuer, Issue, Obligor, etc. Transaction specific constraints may comprise, for example, Turnover, Max Trade Size, Taxes, Basket Capacity, T-Costs, Minimum/Maximum Trade Size, Minimum Holding Size, Round Lots, Minimum/Maximum number of Trades, Maximum turnover rate relative to index turnover, etc. It will be appreciated that the constraints above are offered by way of example only, and additional constraints are contemplated and may be utilized in connection with system 100. An exemplary constraint, key rate duration, is the duration at specific maturity point on the yield curve. Keeping all other maturities constant, key rate duration is a measure of the sensitivity of a bond's price to a 100 basis point change in yield for a given maturity. KRDs may be set to intervals such as, for example, 6 months, 2 years, 5 years, 10 years, 20 years, 30 years, etc. Another exemplary constraint, maximum turnover rate relative to index turnover, may be defined as limiting a turnover rate within 1% bound of an index turnover, for example, if the index turnover is 3%, the fund turnover constraint must be within 2%-4%. It may be desirable for a user to match constraints between one or more fixed income assets and the fixed income index because matching attributes and risk characteristics of a fund with an index may help minimize fund tracking errors.

In some embodiments, the Optimization Client 102 may be configured to set a penalty to penalize deviation between the selected fixed income assets and the selected constraints. For example, if a constraint was set to limit issuer exposure to 1% of market value, a penalty could be applied if the selected assets are greater than the desired 1% market value. Penalties may be defined according to user preference regarding the importance of a given constraint. Constraints that are of greater importance may be assigned greater penalties which may guide the optimization engine 104 to give greater prioritization to the constraint, in view of the associated penalty. Constraints can also have explicit, hard upper bounds and lower bounds that prohibit a certain segment of the portfolio from deviating a certain threshold (e.g. no more than 10% HY bonds) which can ensure that fund managers adhere to guidelines and constraints of the portfolio.

After a user has selected the constraints associated with the desired one or more fixed income assets, the Optimization Client 102 may transmit the selected constraints to an Optimization Engine 104. The Optimization Engine 104 is configured to gather data related to available fixed income assets via the Knowledge Engine 106. Knowledge Engine 106 may be connected to an Index Feed 108, Positions database 110, and/or Compliance database 112. These sources of information allow the Knowledge Engine 106 to retrieve information related to fixed income assets. For example, Index Feed 108 may contain information related to various fixed income indexes, such as the Barclay US aggregation index, Barclay Global Corporate index, the JPM GBI index, the JPM EMBI index, etc. In some embodiments, Knowledge Engine 106 may be configured to retrieve index information from Index Feed 108 in real-time or near real-time. Knowledge Engine may be further configured to retrieve fund positions of a user from Positions database 110. In some embodiments, Positions database 110 contains information relating to non-user related positions or holdings, e.g. institutional holdings. Knowledge Engine 106 may be further configured to retrieve compliance information from Compliance database 112. Compliance database 112 may comprise information related to regulatory or statutory requirements concerning fixed income assets. In some embodiments, Compliance database 112 is configured to automatically update compliance information stored thereon in order to avoid identifying non-compliant fixed income assets. In certain embodiments, information from Compliance database 112 may be utilized by the Optimization Engine 104 to conduct a compliance check. A compliance check may identify and exclude certain securities from selection due to compliance related constraints to ensure that the identified securities are not part of a generated trade list. In certain embodiments, the Optimization Engine 104 may generate a compliance report for audit purposes. In other embodiments, Optimization Engine 104 may generate a notification or alert to indicate that the parameters and constraints selected by the user at Optimization Client 102 would select or more non-compliant fixed income assets. This notification or alert could be optionally displayed to a user at Optimization Client 102.

After fixed income information has been retrieved and/or received from the Knowledge Engine 106, Optimization Engine 104 may be configured to generate an optimization problem. The optimization problem may comprise one or more variables related to the constraints selected by the user at the Optimization Client 102 in view of the fixed income asset information obtained from the Knowledge Engine 106. In some embodiments, the optimization problem may categorize the constraints into linear, quadratic, or combinatorial constraints. The optimization problem generated by the Optimization Engine 104 may be configured to additionally consider investment objectives, e.g. achieving desired attributes and risk characteristics of a fund, consideration of tax implications including avoidance of securities that may trigger wash sales, security lending, consideration of liquidity of the underlying instruments in a fund, consideration of upcoming flows, distributions, expenses, reimbursements and fees, considerations of upcoming changes to the fixed income index that a fund may be benchmarked against, etc. Certain objectives may be considered by the Optimization Engine 104, for example, by minimizing the sector weight deviation between a fund and index, by maximizing environmental, social, and governance components of the optimization problem, by maximizing the quality, momentum, and value components of the optimization problem, by minimizing the tax liabilities, etc. In some embodiments, the optimization problem is configured to match fixed income index statistics at an overall portfolio level and/or within separate currencies. In certain embodiments, the Optimization Engine 104 may integrate a slack variable within the generated optimization problem. Slack variables allow for the selection of fixed income assets that violate the selected constraints as long as a penalty is applied.

Once the Optimization Engine 104 finalizes the optimization problem, the Optimization Engine 104 may convert the optimization problem into a mixed integer programming (MIP) problem. The Optimization Engine 104 may transmit the MW problem to Solver 114. Solver 114 may be any mathematical processing system configured to solve linear MW problems, for example, the Gurobi solver by Gurobi Optimization. In certain embodiments, the Optimization Engine 104 may comprise the solver 114. Once a solution to the MIP problem is generated by the Solver 114, the result is obtained by the Optimization Engine 104 where the MIP problem solution is used to generate to an optimized fixed income trade list. After the optimized fixed income trade list is generated, the Optimization Engine 104 may transmit the optimized fixed income trade list to the Optimization Client 102 for display to a user. In some embodiments, the Optimization Client 102 may create a visualization illustrating fixed income asset holdings before and after optimization by the Optimization Engine 104. In certain embodiments, Optimization Client 102 may be configured to execute fixed income asset trades according to the optimized fixed income trade list. Optimization Engine 104 and/or Optimization Client 102 may generate an audit log to track constraints applied in various iterations of the optimized fixed income trade list, and trades executed therefrom. In some embodiments, the audit log is transmitted to the Knowledge Engine 106.

It will be appreciated that he various modules and engines of system 100 as described with reference to FIG. 1 may be in electronic communication with one another, e.g. over a network, such as the Internet or intranet network. It will be further appreciated that each engine or module of system 100 may be implemented on one or more computers, e.g. a distributed computing environment, where the processing done at each module or engine may be spread across one or more computers.

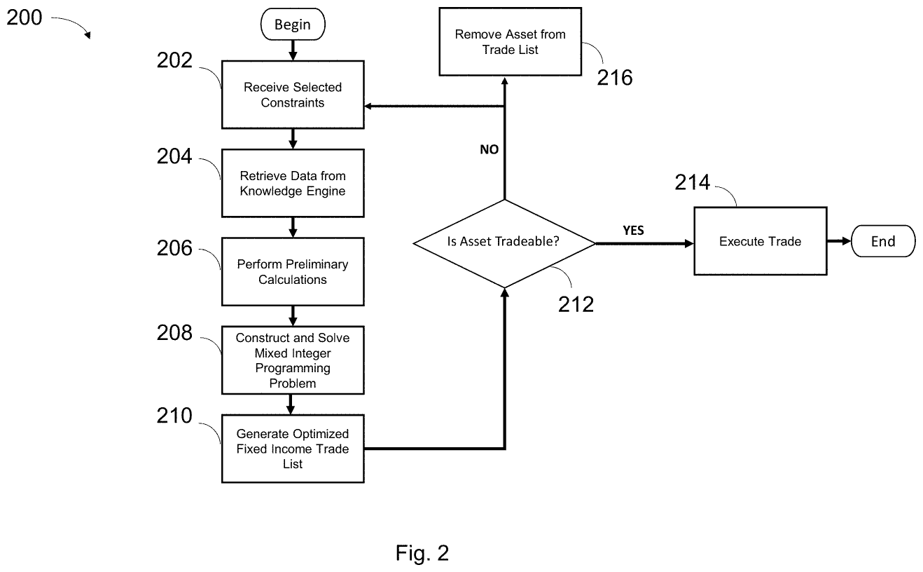

FIG. 2 illustrates a flow chart of an exemplary method for executing an optimized fixed income asset trade. It will be appreciated that the illustrated method and associated steps may be performed in a different order, with illustrated steps omitted, with additional steps added, or with a combination of reordered, combined, omitted, or additional steps.

At step 202, one or more selected constraints associated with a potential fixed income asset trade are received. As previously discussed, constraints further specify what type of fixed income asset is desired and/or what index related statistics should be matched. The constraints may be received as selections from a user interface, e.g. Optimization Client 102. After desired constraints are identified, at step 204, fixed income asset information is retrieved from a knowledge source, e.g. Knowledge Engine 106.

At step 206, preliminary calculations may be performed. Such calculations may include resolving instruments, quoting bond price, calculating bond analytics, quote fx rates, etc. In some embodiments, these calculations are performed in Knowledge Engine 106. At step 208, a mixed integer programing (MIP) problem is generated, e.g. by Optimization Engine 104, and solved, e.g. by Solver 114. At step 210, an optimized fixed income trade list is generated, e.g. by Optimization Engine 104.

At step 212, the optimized fixed income trade list may be parsed and for each identified fixed income asset, it may be determined if that asset is tradeable. An asset may be determined to be non-tradeable if it has been identified and/or excluded for compliance reasons. An asset may also be determined to be non-tradeable if there is a lack of liquidity in the market, e.g. a wide bid/ask spread. If the identified fixed income asset is determined to be tradeable, the trade is executed at step 214. If the fixed income asset is determined to be non-tradeable, the asset is removed from the list at step 216. In some embodiments, if the asset is determined to be non-tradeable, the method may return to step 202 and adjust or modify the selected constraints.

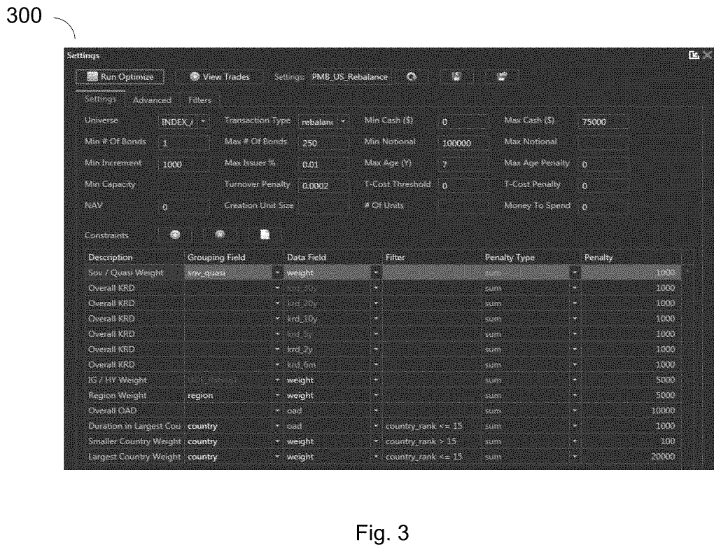

FIG. 3 shows a screenshot of an exemplary user interface 300 for an exemplary fixed income optimization system. User interface 300 may comprise the same features and functionality as described with reference to Optimization Client 102.

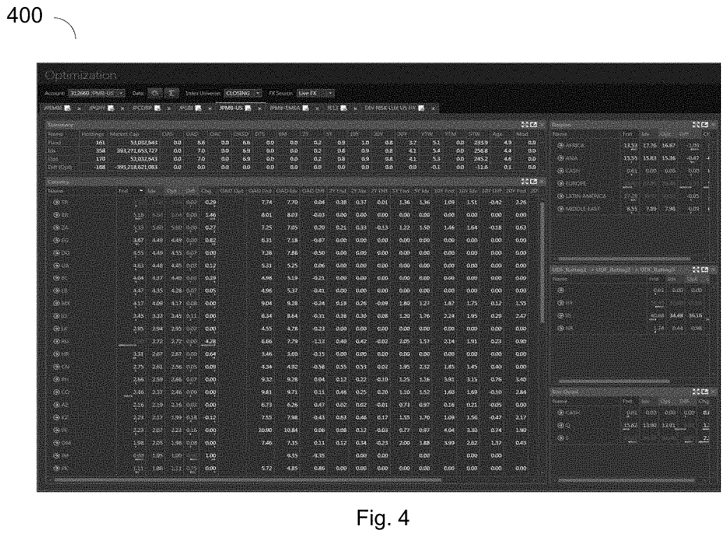

FIG. 4 shows a screenshot of an exemplary user interface 400 for an exemplary fixed income optimization system. User interface 400 may comprise the same features and functions as described with reference to Optimization Client 102, specifically, after optimization has been performed.

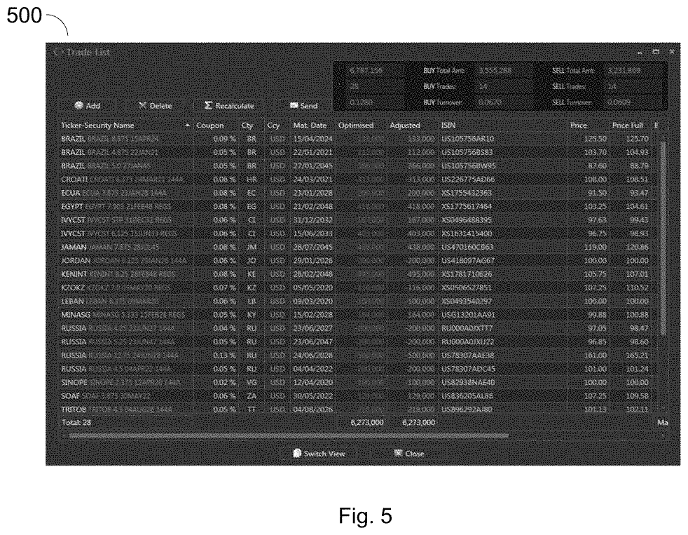

FIG. 5 shows a screenshot of an exemplary user interface 500 for an exemplary fixed income optimization system. User interface 500 may comprise the same features and functions as described with reference to Optimization Client 102, specifically, when displaying an optimized fixed income trade list.

The term “module” or “engine” used herein will be appreciated as comprising various configurations of computer hardware and/or software implemented to perform operations. In some embodiments, modules or engines as described may be represented as instructions operable to be executed by a processor and a memory. In other embodiments, modules or engines as described may be represented as instructions read or executed from a computer readable media. A module or engine may be generated according to application specific parameters or user settings. It will be appreciated by those of skill in the art that such configurations of hardware and software may vary, but remain operable in substantially similar ways.

It is to be understood that the detailed description is intended to be illustrative, and not limiting to the embodiments described. Other embodiments will be apparent to those of skill in the art upon reading and understanding the above description. Moreover, in some instances, elements described with one embodiment may be readily adapted for use with other embodiments. Therefore, the methods and systems described herein are not limited to the specific details, the representative embodiments, or the illustrative examples shown and described. Accordingly, departures may be made from such details without departing from the spirit or scope of the general aspects of the present disclosure.

1. A system for managing fixed income assets, the system comprising:
an optimization client configured to accept selection of at least one constraint associated with fixed income assets;
a knowledge engine configured to retrieve data related to available fixed income assets, wherein the retrieved data comprises at least index data from a fixed income index feed; and,
an optimization engine configured to:
generate an optimization problem based on the at least one constraint and the data retrieved by the knowledge engine;
solve the optimization problem; and,
generate an optimized fixed income trade list based on the solved optimization problem.

2. The system of claim 1, wherein the knowledge engine is configured to retrieve data from the fixed income index feed in real-time or near real-time.

3. The system of claim 1, wherein the optimization problem is configured to generate the optimization problem based on the at least one constraint, the data retrieved by the knowledge engine, and at least one penalty.

4. The system of claim 1, wherein the optimization problem is a Mixed Integer Programming (MW) problem.

5. The system of claim 1, wherein the optimization engine is further configured to conduct a compliance check based on data retrieved by the knowledge engine.

6. The system of claim 1, wherein the optimization engine is further configured to generate an audit list.

7. The system of claim 1, wherein the optimization engine is further configured to solve the optimization problem using a solver.

8. The system of claim 1, wherein the optimization client is further configured to transmit the optimized fixed income trade list to the optimization client.

9. The system of claim 8, wherein the optimization client is further configured to display the optimized fixed income trade list.

10. A method for managing fixed income assets, the method comprising:
receiving at least one constraint associated with fixed income assets;
receiving data from a knowledge engine, wherein the data received comprises at least index data from a fixed income index feed;
generating an optimization problem based on the at least one constraint and the data received by the knowledge engine;
solving the optimization problem;
generating an optimized fixed income trade list based on the solved optimization problem.

11. The method of claim 10, further comprising determining if a fixed income asset on the optimized fixed income trade list is tradeable.

12. The method of claim 11, further comprising, executing a trade of the fixed income asset if it is determined to be tradeable.

13. The method of claim 10, wherein the index data received from the fixed income index feed is received in real-time or near real-time.

14. The method of claim 10, wherein the optimization problem is a Mixed Integer Programming (MW) problem.

15. The method of claim 10, further comprising conducting a compliance check based on data retrieved by the knowledge engine.

16. The method of claim 10, further comprising generating an audit list.

17. The method of claim 10, wherein solving the optimization problem is accomplished using a solver.

18. The method of claim 10, further comprising displaying the optimized fixed income trade list at an optimization client.

19. A system for managing fixed income assets, the system comprising:
an optimization client configured to:
select at least one constraint associated with fixed income assets;
transmit the selected at least one constraint to an optimization engine;
receive an optimized fixed income trade list from the optimization engine; and,
execute at least one trade associated with the optimized fixed income trade list.

20. The system of claim 19, wherein the optimized fixed income trade list is based on at least one constraint, data retrieved by a knowledge engine, and at least one penalty.
